(19) United States
(12) Patent Application Publication
(10) Pub. No.: US 2014/0287842 A1
(43) Pub. Date: Sep. 25, 2014

(54) Self-attaching fastener manufacturing apparatus and method

(71) Applicants: Mark J. GOTTSCHALL, Celina, OH (US); James A. NICODEMUS, Bradford, OH (US); Frederick J. RATERMANN, Fort Loramie, OH (US)

(72) Inventors: Mark J. GOTTSCHALL, Celina, OH (US); James A. NICODEMUS, Bradford, OH (US); Frederick J. RATERMANN, Fort Loramie, OH (US)

(73) Assignee: CONCEPT MACHINE & TOOL, INC., Covington, OH (US)

(21) Appl. No.: 13/815,996

(22) Filed: Mar. 21, 2013

(51) Int. Cl. F16B 37/06

(52) U.S. Cl. CPC F16B 37/068
USPC 470/25; 470/109

(57) ABSTRACT

The present invention is an assembly line for continuously manufacturing self-attaching fasteners from a metal rod having a predetermined profile. The self-attaching fasteners are joined together with wires and reeled onto spools for use at a secondary installation site. More importantly the invention is an improved streamline method and apparatus which produces burr-free self-attaching fasteners, without deformation, and joins the self-attaching fasteners and wires together within a die press.

### FIELD OF THE INVENTION

The present invention is generally toward a manufacturing apparatus and method which, in an assembly line fashion, manufactures from a metal rod with a predetermined profile, self-attaching fasteners free of burrs and deformation with threaded holes, joined to wires and rolled onto a spool for use at a secondary installation site.

### BACKGROUND OF THE INVENTION

A self-attaching fastener, commonly referred to as a pierce nut, is typically a metal nut which is capable, with the aid of an installation device, of piercing and attaching itself to a panel. This ingenious invention enables typically thin sheet metal panels, which are often formed into various shapes, to have an area within the panel in which an added member may be fastened. Self-attaching fasteners are typically made from a coil of metal rod having a predetermined profile and preformed grooves within, in order for the insertion of wire. Self-attaching fasteners have been used in industry for many decades and the manufacturing methods and processes of these fasteners and more importantly the joining of these fasteners to wires in order to form a strip, for use in secondary operations, is an area of great effort. It is the joining the fasteners to wires, forming a strip, that greatly increases the benefit of a self-attaching fastener, in that the ability to feed the fastener into an installation device and then installing the fastener into a panel of some type becomes a more efficient streamline operation. Yet, manufacturing a fastener to a precise dimension, free of burrs and deformation and joining the fasteners to wires, with increased speed, continues to be challenging. Common problems which occur, in manufacturing a self attaching fasteners, are threaded hole centrality, and as noted burrs and deformation which result from a die press cutting operation. As a result of burring on the individual fasteners, secondary operations such as feeding the fasteners through an installation device can be troublesome and unnecessary maintenance issues can occur within the installation device. As a result of deformation of the fastener, particularly in the pre-formed grooves, inserting wires into the grooves in order to join the fasteners into a strip is challenging and typically requires additional feeding mechanisms, re-grooving stations, carrier wire installation stations, and knurling stations such as the methods used in U.S. Pat. No. 7,367,893 and U.S. Pat. No. 7,744,475.

It is believed that reducing the number of steps and or stations required to manufacture self-attaching fasteners joined by wires, thus forming a continuous strip, has been ignored. Additionally it is believed that the methods that require added steps or stations are a hindrance to the speed and efficiency of an assembly line. Just as the fasteners and installation devices have evolved over the years, so must the methods for manufacturing joined self-attaching fasteners.

Additional literature that may pertain to the manufacturing apparatus and method discussed herein include the following patent documents: U.S. Pat. No. 7,744,475; U.S. Pat. No. 7,367,893; U.S. Pat. No. 7,338,245; U.S. Pat. No. 6,997,659; U.S. Pat. No. 6,925,698; U.S. Pat. No. 6,578,258; U.S. Pat. No. 6,631,827; U.S. Pat. No. 6,021,562; U.S. Pat. No. 5,383,021; U.S. Pat. No. 5,348,429; U.S. Pat. No. 5,016,461; U.S. Pat. No. 4,971,499; U.S. Pat. No. 3,971,116; U.S. Pat. No. 3,845,860; U.S. Pat. No. 3,718,965; and U.S. Pat. No. 3,711,931, all incorporated by reference for all purposes.

### SUMMARY OF THE INVENTION

The present invention is intended to provide a solution to current time consuming methods of joining self-attaching fasteners to wires and it is believed that the inventive manufacturing apparatus and method disclosed has the advantage of producing dimensionally precise self-attaching fasteners, free of burrs and deformation, joined in a continuous wire strip, more efficiently and at greater speeds.

Accordingly, the first station of the manufacturing apparatus and method consists of a coil of metal rod with a predetermined profile. The second station of the manufacturing apparatus and method is two-part wherein the coil metal rod is pulled from the first station and straightened from a coiled condition. The third station of the manufacturing apparatus and method advances the metal rod into the fourth station with incremental movements. The fourth station of the manufacturing apparatus and method involves an articulating die press which consists of and performs the following steps: a hole piercing area for piercing two holes through the metal rod; a piloting and hole sensor area for sensing the presence of the pierced through hole and pilot pins for precisely positioning the metal rod within the die press; a chamfer punching area for punching a form on the top surface of the pierced through holes; a blanking area for cutting the metal rod to a precise size thus creating an individual fastener; a wire installation area for introducing two wires into grooves in the individual fastener; a wire coining area for spacing and joining the wires to the individual fasteners thus forming a strip. The fifth station of the manufacturing apparatus and method is a timing station which controls the timing relationship between station four and station six. The sixth station of the manufacturing apparatus and method is a tapping, inspection, and pulling machine which performs three actions. The first action clamps the joined fastener strip and forms threads into the through holes in the individual fasteners; the second action inspects the presence of or lack thereof formed threads in the joined fastener strip; the third action consists of a pulling device which advances the joined fastener strip to the next station. The seventh station of the manufacturing apparatus and method is two-part wherein the fasteners are counted and reeled onto spools for use a secondary installation site.

It is believed that the inventive methods contained in the station four die press are an improvement over current methods, such as those used in U.S. Pat. No. 7,744,475 and prior methods of wire installation. Typically, the action of cutting the metal rod tends to deform the pre-formed grooves within the metal rod resulting in an inconsistent installation of the wires by a wire insertion device. By cutting the metal rod in a manner in which the cut fastener is burr-free and free of deformation and a double coining action of joining the fasteners and the wires within the die press, the need for additional stations has been eliminated.

### BRIEF DESCRIPTION OF THE DRAWINGS

The present invention may be appreciated and understood by reference to the following description of the invention in conjunction with the accompanying drawings wherein:

FIG. 1 shows a top view of a schematic of the present inventive assembly;

FIG. 2 shows a frontal view of a schematic of the present inventive assembly;

FIG. 3 shows a top view of the inventive station four bottom die press assembly of the present invention;

FIG. 4 shows a side section view of the inventive station four die press assembly of the present invention in a retracted position;

FIG. 4A shows a side section view of the inventive station four die press assembly of the present invention in an actuated position;

FIG. 5 shows a partial end section view of the inventive die press pilot area of the present invention in a retracted position;

FIG. 5A shows a partial end section view of the inventive die press pilot area of the present invention in an actuated position;

FIG. 5B shows a partial end section view of the inventive die press blanking area of the present invention in an actuated position;

FIG. 6 shows a partial end section view of the inventive die press coining area of the present invention in a retracted position;

FIG. 6A shows a partial top view of the inventive die press wire installation area of the present invention;

FIG. 7 shows a partial side view of the inventive die press wire coining area of the present invention in a retracted position;

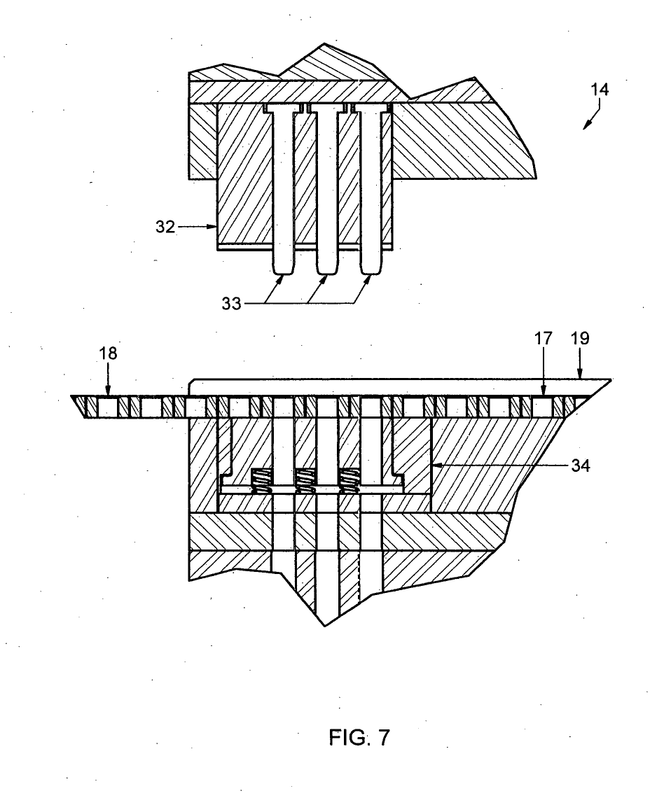

FIG. 7A shows a partial side view of the inventive die press wire coining area of the present invention in an actuated position;

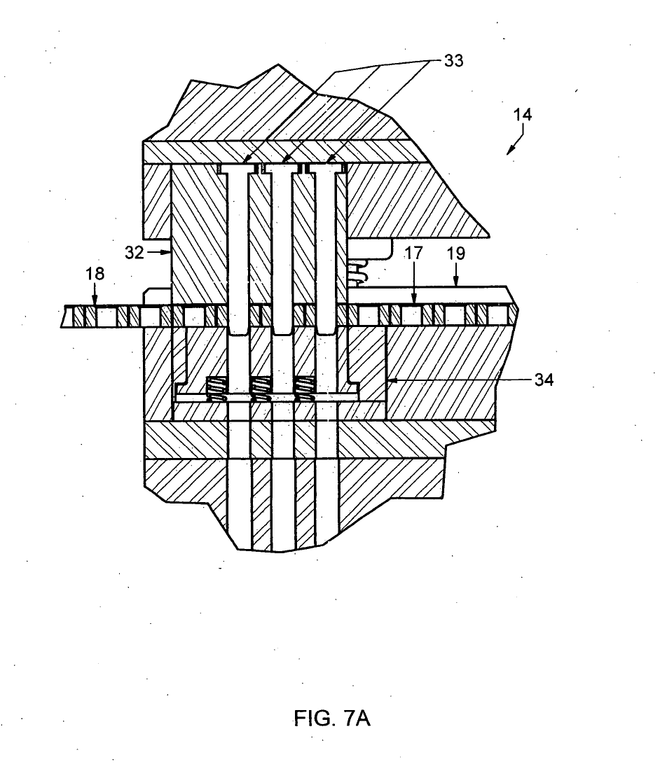

FIG. 8 shows a frontal view of the inventive station five timing mechanism of the present inventive assembly;

FIG. 9 shows a frontal view of the station six tapping/inspection/pulling machine of the present inventive assembly;

FIG. 9A shows a frontal partial view of the station six tapping/inspection/pulling machine of the present inventive assembly;

FIG. 9B shows a frontal partial view of the station six tapping/inspection/pulling machine of the present inventive assembly; and

FIG. 10 shows a frontal view of the station seven spooling/reeling mechanism of the present inventive assembly.

### DETAILED DESCRIPTION OF THE INVENTION

The following described invention is an improved self-attaching fastener 17 manufacturing apparatus and method for continuously manufacturing self-attaching fasteners 17, at a high rate of speed, from a coiled metal rod 10 with a predetermined profile resulting in a burr-free self-attaching fasteners 17 joined by wires 30 and reeled onto a spool 52 for use at a secondary installation site.

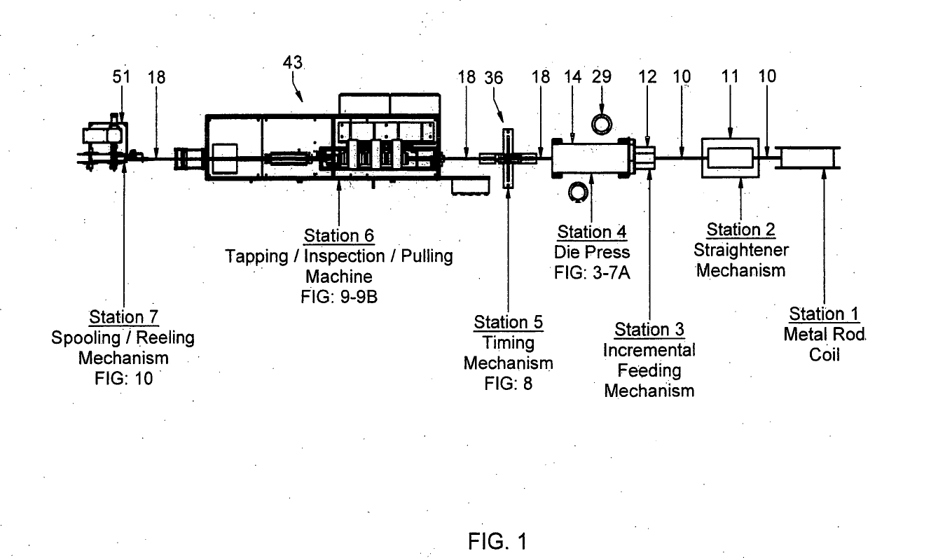

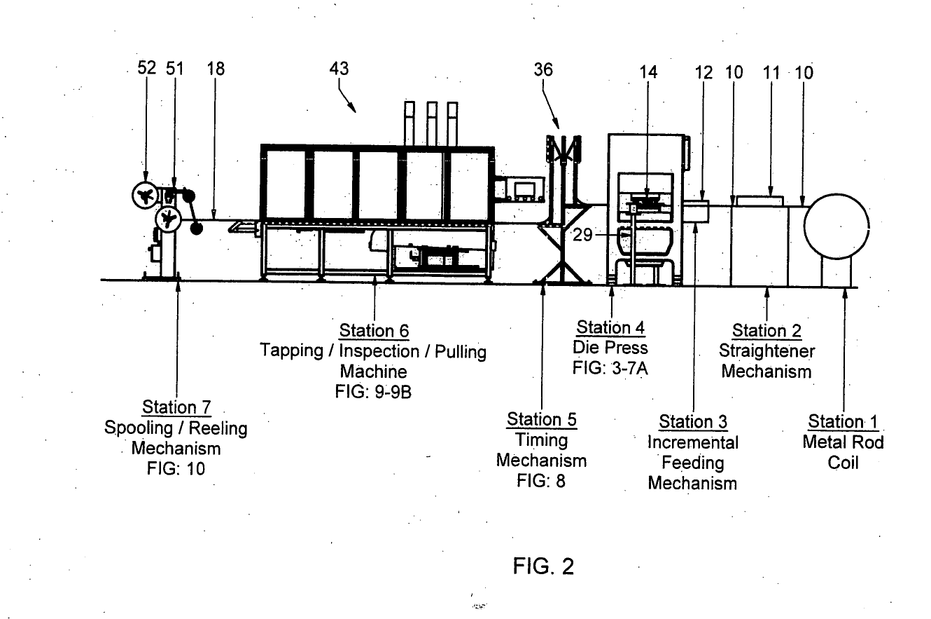

Referring to FIGS. 1 and 2, the manufacturing process begins at station one where metal rod 10 with a predetermined shape is situated in a coil state. The metal rod 10 is pulled from the coil state by a station two straightener mechanism 11 which is compatible with the speed of the entire assembly line. Next, the metal rod 10 advances to station three where an incremental feeding mechanism 12 advances the metal rod 10 into the station four die press 14.

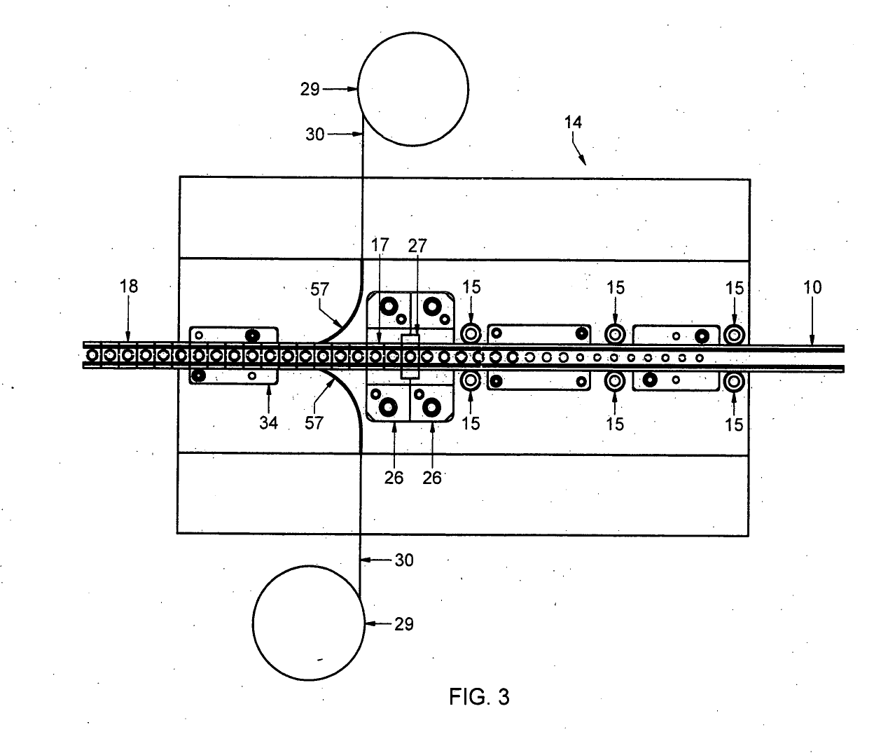

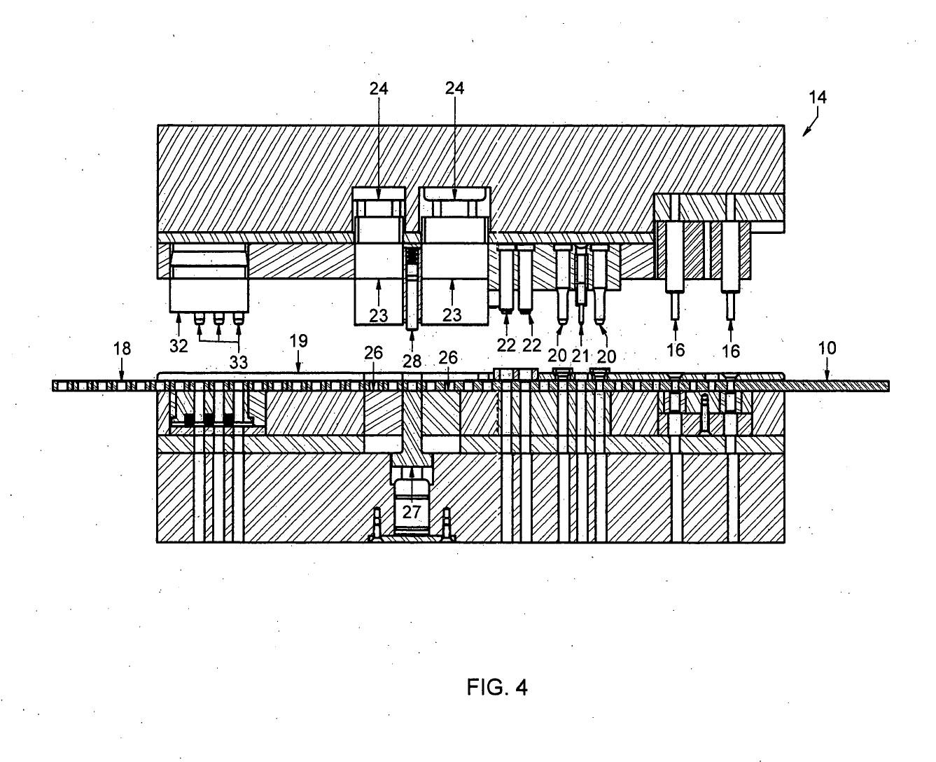

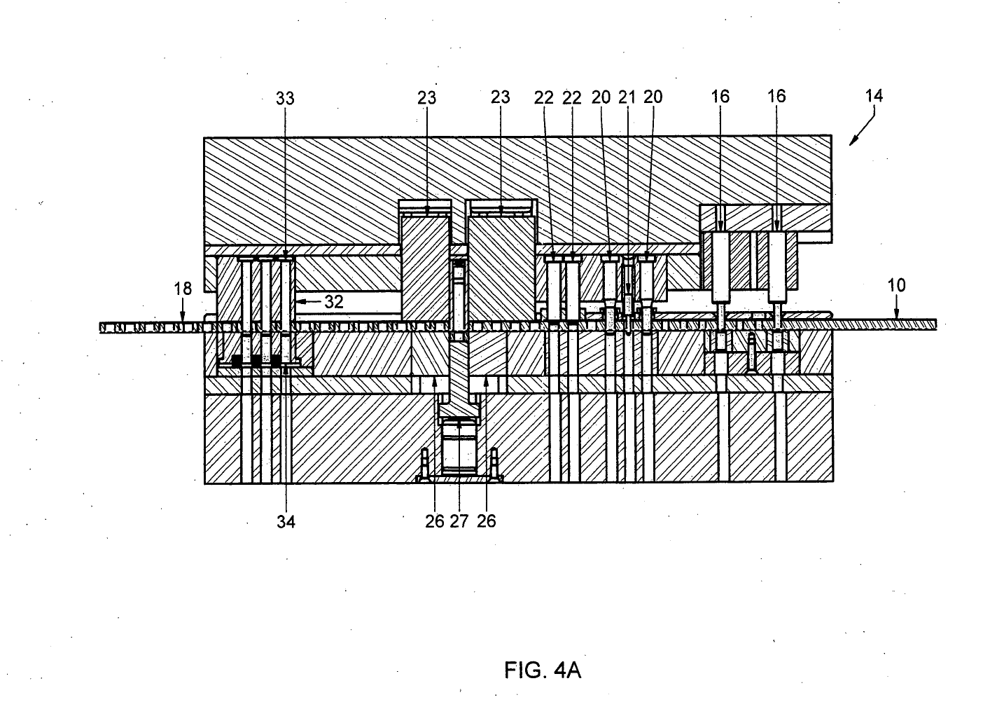

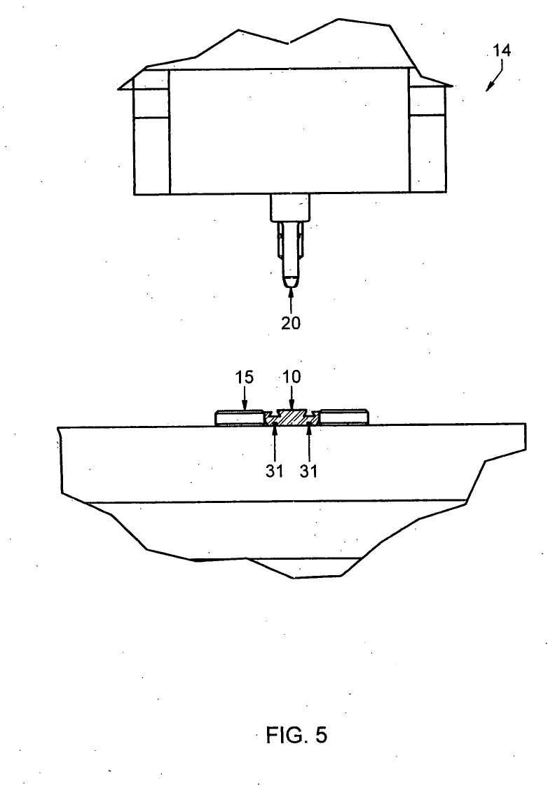

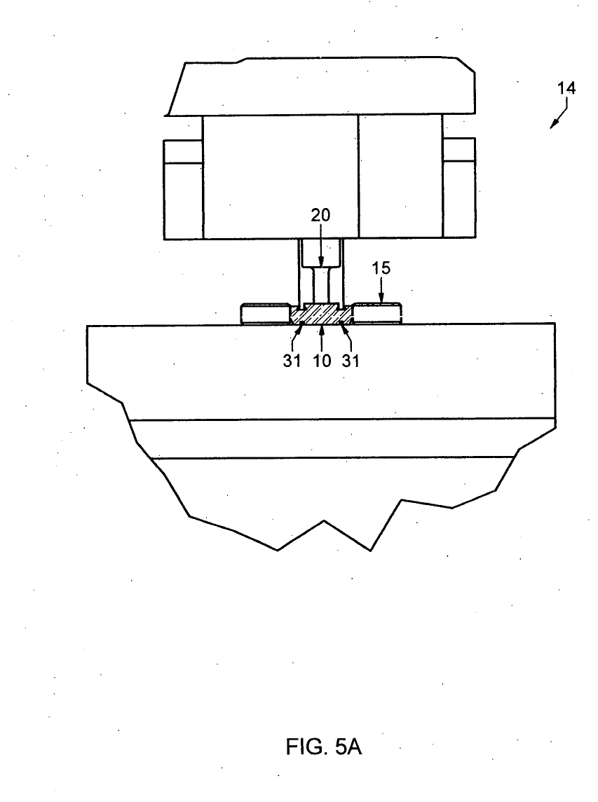

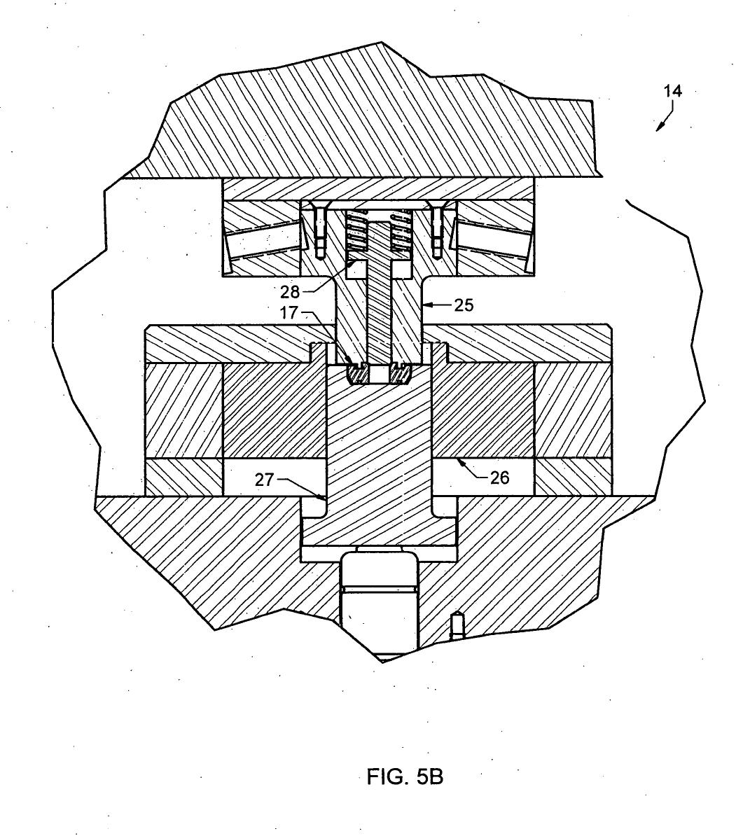

Referring to FIGS. 3 thru 7-A. Within the station four die press 14 an improved manufacturing process consisting of seven steps begins. In order to maintain a precise central hole location within the fastener 17, which will receive a formed thread, a series of rollers 15 provide a minimal movement condition as the metal rod 10 continuously advances through the die press 14 (FIG. 3). Upon actuation of the die press 14, the first step is to drive two pierce punches 16, at a predetermined distance from each other, through the metal rod 10 (FIG. 4A). Upon retraction of the die press 14, the metal rod 10 incrementally advances the approximate width of two fasteners 17. Upon actuation of the die press 14, the second step is to detect the presence of the pierced holes with sensors 21 and precisely position the metal rod 10 with two pilot pins 20 which enter the pierced holes (FIG. 4A). Upon retraction of the die press 14 the metal rod 10 is incrementally advanced the approximate width of two fasteners 17. The third step, upon actuation of the die press 14, is to drive two formed punches 22 into the top surface of the two pierced holes, thus forming a chamfer (FIG. 4A). Upon a series of retractions of the die press 14 the metal rod 10 will incrementally advance to an area within the die press 14 where step four occurs wherein the metal rod 10 becomes a single fastener 17 by a cutting action. The cutting action, as should be known to those experienced in the manufacturing of self-attaching fasteners, can cause burring on the outer contours of the fastener 17 and may deform the preformed grooves 31 on the surface of the metal rod 10. The purpose of the pre-formed grooves 31 as is best represented in FIGS. 5 and 5-A will be more evident and further explained below.

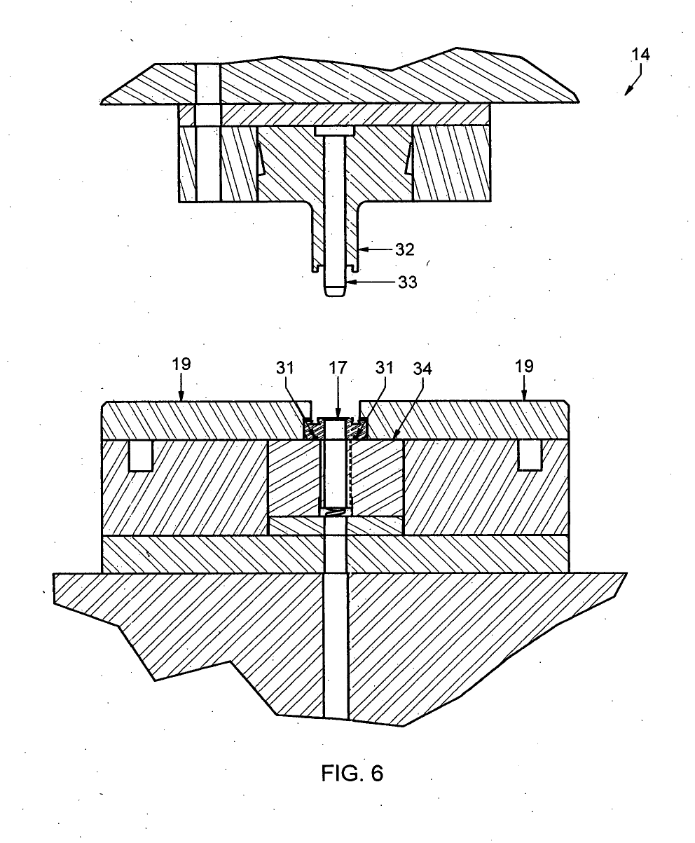

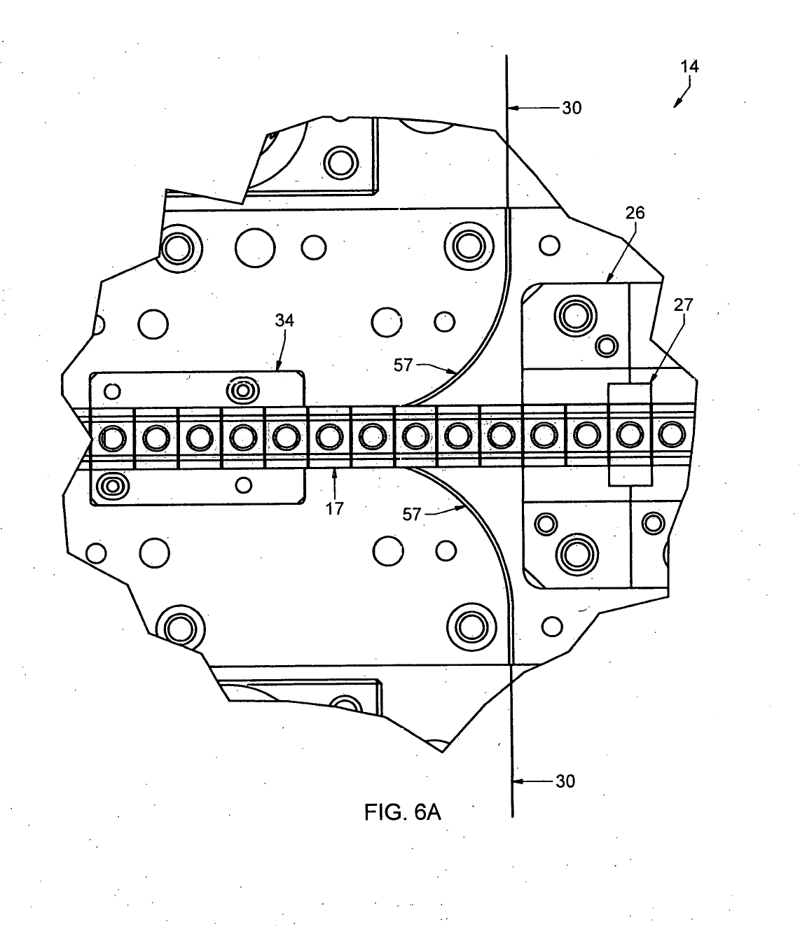

Upon actuation of the die press 14 a two-part action occurs. Two upper pressure pads 23 of a certain width and configuration matching that of the predetermined profile of the top surface of the metal rod 10 will drive downward and in conjunction with high pressure springs 24 will contain the metal rod 10 (FIGS. 4 and 4A). Additionally an upper cutting member 25 of a certain width and configuration matching that of the predetermined profile of the top surface of the metal rod 10 will drive downward forcing the metal rod 10 to pass through two lower cutting members 26 of a certain spacing and configuration matching that of the predetermined profile of the lower surface of the metal rod 10. This action produces a predetermined dimensional width for one fastener 17 and provides a cut edge for a second fastener 17. Upon retraction of the die press 14, a lifting member 27 of a certain width and configuration matching that of the predetermined profile of the lower surface of the metal rod 10 and in correlation with a containment device 28 in the top cutting member 25 returns the now cut fastener 17 to a position where the metal rod 10 and the fastener 17 will incrementally advance the length of two fasteners 17 (FIGS. 4A and 5B). Upon actuation of the die press 14, the previous action will repeat and upon retraction of the die press 14, two fasteners 17 have been cut to a predetermined dimensional width thus completing step five. It is this action which results in what is known to those skilled in the art as a “two-out” situation. Upon this previous described action repeating a predetermined number of times a series of cut fasteners 17 advance to a location within the die press 14 wherein step six occurs. In this step, two wire carriers 29 introduce wires 30 into the pre-formed grooves 31 in the now cut fastener 17. The wires 30 are contained within the fastener 17 by introducing the wires 30 in a wire introduction area 57 in the die press 14 and by vertical resistance upon the top surface of the fastener 17 by a fastener containment guide 19 (FIGS. 6 and 6A). After a series of predetermined incremental advancements of the fasteners 17 and the metal rod 10 step six is completed and the cut fasteners 17 are positioned within the die press 14 for the final step. Upon actuation of the die press 14, step seven, consisting of two actions, simultaneously positions and joins the fastener 17 to the two introduced wires 30. An upper forming member 32, located above the fastener 17, containing locating pins 33, drives downward causing a locating pin 33 to enter the pierced hole of the fastener 17 and making contact with the top surface of the fastener 17. This drives the fastener 17 in contact with a lower coining member 34 on the bottom surface of the fastener 17 causing the fastener 17 and the two introduced wires 30 to join together. Upon retraction of the die press 14, the joined fastener 17 and wires 30, in conjunction with the metal rod 10 and the cut fasteners 17 incrementally advance the approximate length of two fasteners 17 to a location where the second action of step seven will occur. Upon actuation of the die press 14, the aforementioned upper forming member 32 located above the fasteners 17, in conjunction with the contained locating pins 33, drives downward causing the locating pins 33 to enter the pierced holes of three fasteners 17 while simultaneously spacing the fasteners 17 a predetermined distance from each other and making contact with the top surface of the three fasteners 17. This drives the three fasteners 17 in contact with the aforementioned lower coining member 34 on the bottom surface of the fasteners 17 causing the fasteners 17 and the two introduced wires 30 to join together again resulting in a joined fastener strip 18. Upon retraction of the die press 14, the now joined fastener strip 18, in conjunction with the metal rod 10 and the cut fasteners 17 may incrementally advance in a horizontal fashion exiting the station four die press 14 (FIG. 6A thru 7A).

The improved manufacturing process of the station four die press 14, consisting of seven steps described above, eliminates the need for additional feeding mechanisms, re-grooving stations, carrier wire installation stations, and knurling stations such as those previously mentioned. It is believed that the inventive method of matching the configuration of the upper cutting member 25, the two upper pressure pads 23, the two lower cutting members 26, and the lifting member 27 with the predetermined profile of the metal rod 10 is essential to producing a burr-free fastener 17 free of deformation to the pre-formed wire grooves 31. Additionally, it is believed that the inventive steps of the station four die press 14 are an improved and preferred method of joining fasteners to wires and it should be understood by those experienced in the art that various changes may be made and equivalents may be substituted for elements thereof without departing from the scope of the station four die press 14. Additionally, many modifications may be made to adapt a particular situation or material to the teachings of the station four die press 14 without departing from the essential scope thereof.

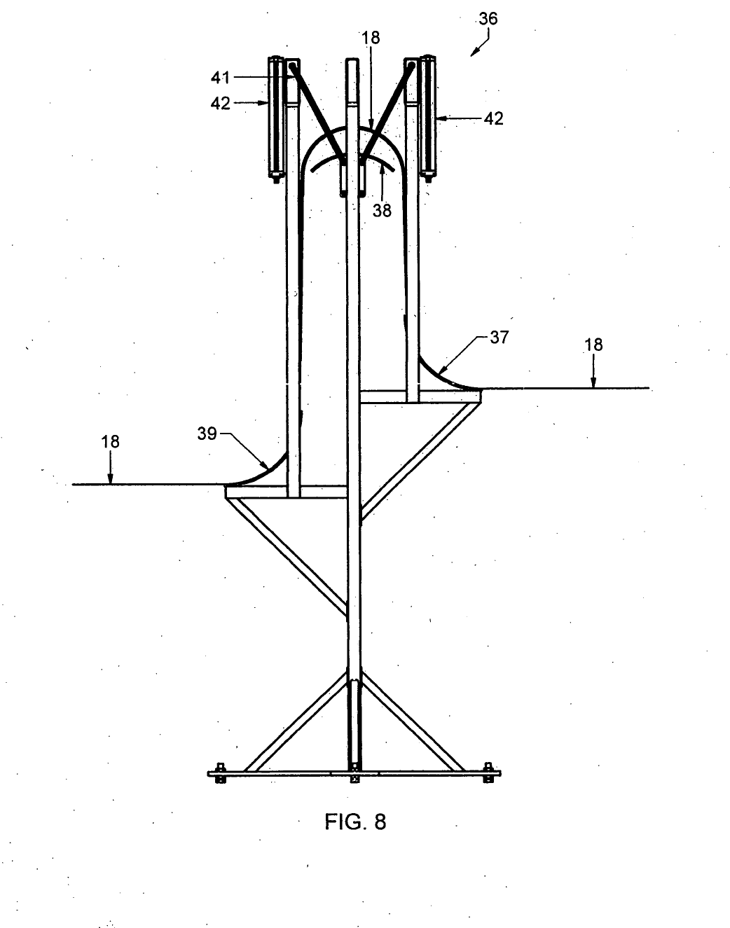

Referring to FIGS. 1, 2. As the station three feed mechanism 12 continues to feed the metal rod 10 and joined fastener strip 18 through the station four die press 14, the continuous joined fastener strip 18 will flow through a continuous track of a station five timing mechanism 36. The timing mechanism 36 functions to control a relationship of timing between the speed and operation of the station four die press 14 and the speed and operation of the station six tapping/inspection/pulling machine 43. As shown in FIG. 8, the timing mechanism 36 consists of an upward vertical radial track 37, subsequently followed by a separate section of radial track 38 capable of moving independently in an upward or downward vertical direction, subsequently followed by a downward vertical track 39. The separate section of radial track 38 is capable of moving vertically by a roller guide system and a four point spring system 41. Electronic light beam controllers 42 located horizontally on each side of the separate section of radial track 38 monitor the position of the separate section of radial track 38 and the joined fastener strip 18 as it continually flows through the tracking system of the timing mechanism 36. With the use of predetermined parameters, the electronic light beam controllers 42 regulate the speed and operation between the station four die press and the speed and operation of the station six tapping/inspection/pulling machine by sensing when the separate section of radial track 38 and the joined fastener strip 18 is in an upmost vertical position or an opposing vertical position within the tracking system. Thus by programmable parameters, the flow and position of the joined fastener strip 18 within the timing mechanism 36 can be monitored, in turn controlling the speed and operation of the station four die press and the station six tapping/inspection/pulling machine.

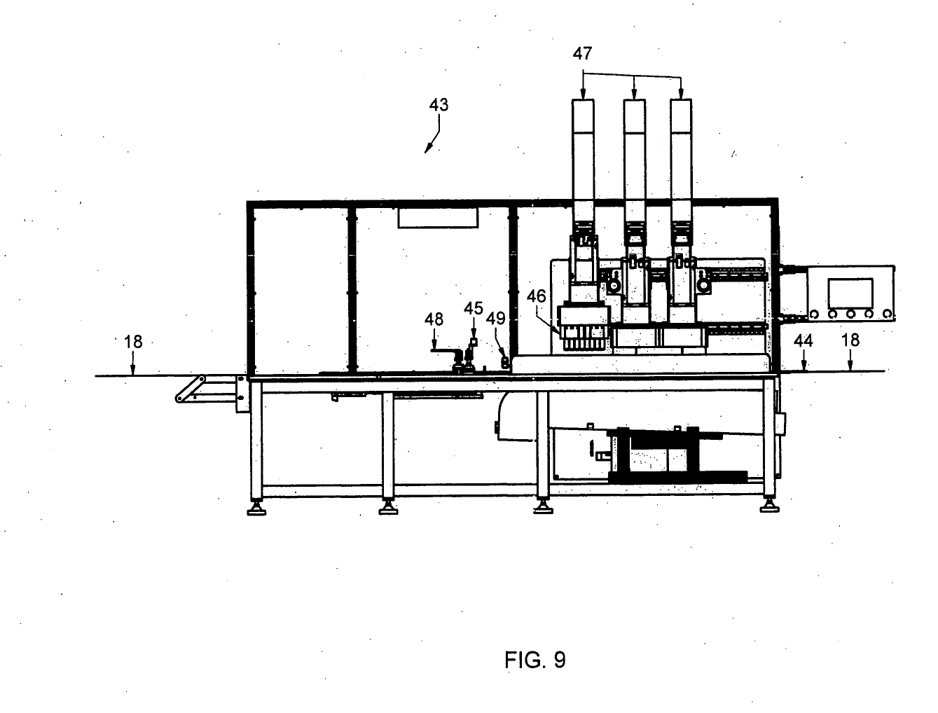

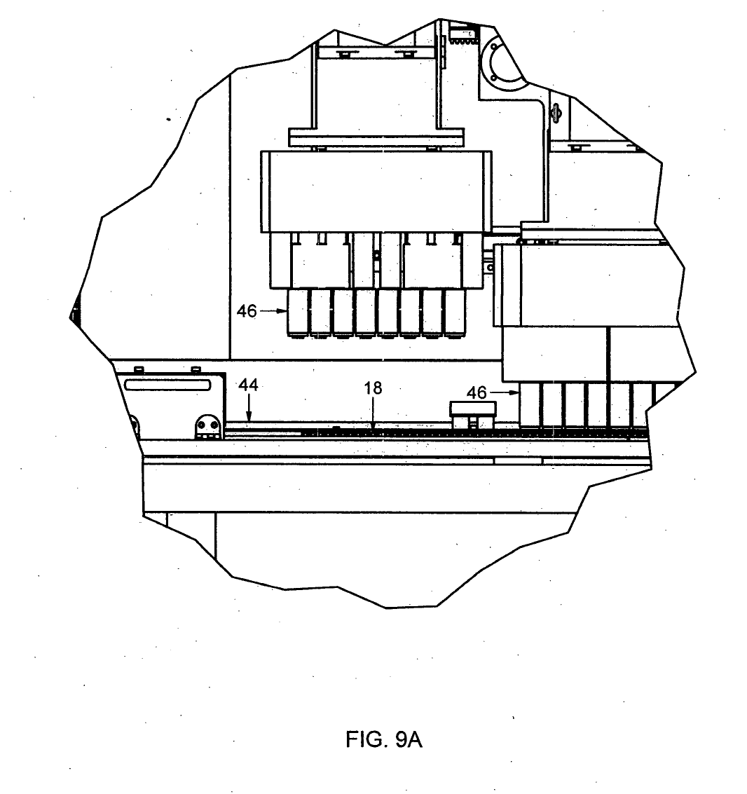

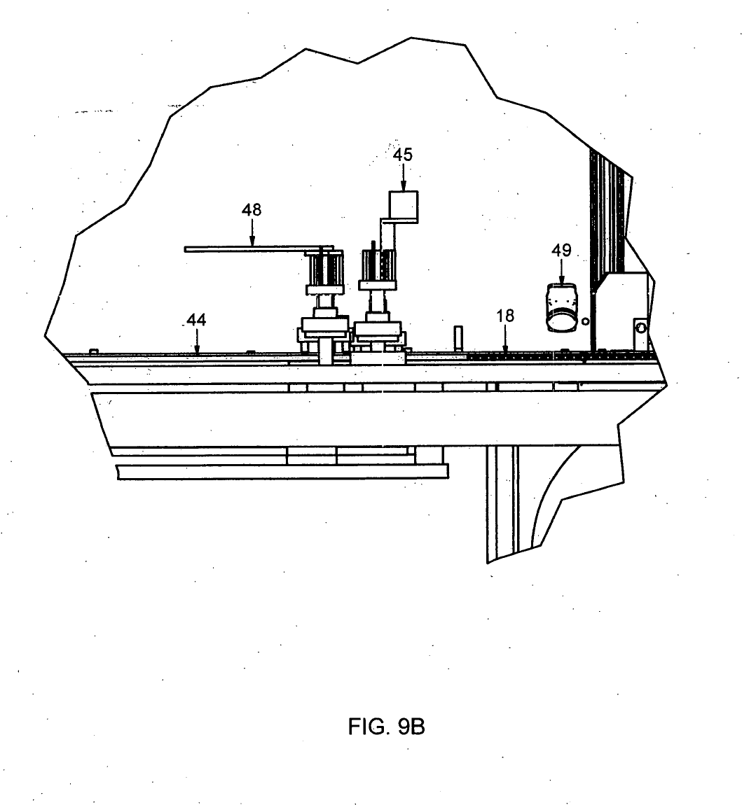

Referring to FIGS. 1, 2. Subsequently following the station five timing mechanism 36 is a tapping/inspection/pulling machine 43. As shown in FIGS. 9 thru 9B, the machine 43 contains a continual track 44 providing an area that the joined fastener strip 18 advances through. A clamping device 45 is used to secure the joined fastener strip 18 in a predetermined location within the continual track 44. The machine 43 includes a plurality of tappers 46, located above the joined fastener strip 18, which are used to form threads into the pierced holes of the individual fasteners. Each tapper 46 is mounted upon an actuator 47 and by computerized controlled motors move in a downward vertical direction. Each tapper 46 floats in a horizontal radial direction independent of the other tappers 46 in order to maintain a constant vertical axis as the tapper 46 is forming threads into the pierced hole of the fastener. By electronic signals and programmed parameters, the tapper 46 will then move in an upward vertical direction. Electronic signals will then release force on the clamping device 45 allowing a pulling device 48 to make contact with the joined fastener strip 18 and advance the joined fastener strip 18 to a predetermined secondary location. A high speed inspection camera 49 subsequent to the tappers 46 monitors the presence of or lack thereof a formed thread in the fasteners and by electronic signaling may halt the advancement of the joined fastener strip 18 through the assembly line. Subsequent to the high speed inspection camera 49, the joined fastener strip 18, may then advance horizontally through the continual track 44 to a cleaning area in preparation for advancement to a station seven spooling/reeling mechanism 51.

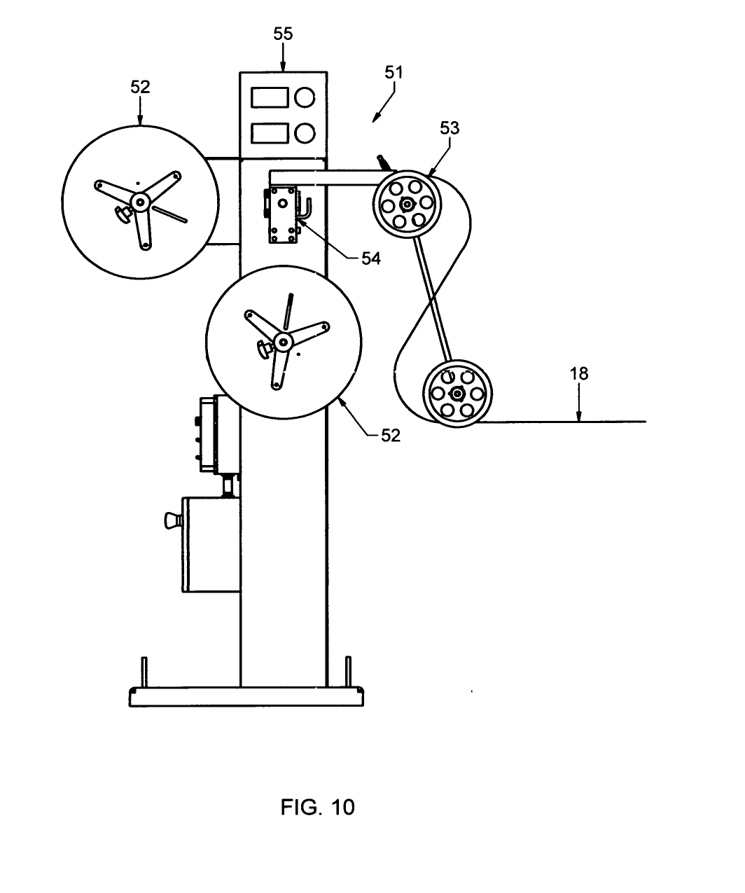

Referring to FIGS. 1, 2. It is at this point that the joined fastener strip 18 advances through a spooling/reeling mechanism 51 which will count the individual fasteners, and reel in a winding action, the joined fastener strip 18 onto a spool 52. As shown in FIG. 10, the spooling/reeling mechanism 51 consists of a radial tracking wheel 53 capable of tracking the individual fasteners that flow across the wheel 53. The radial tracking wheel 53, in conjunction with an electronic programmable counting device 55 can, at pre-set parameters, control the winding action. Directing uniform consistent winding of the joined fastener strip 18 onto the spool 52 is accomplished by the use of a flying bridge device 54 which traverses the joined fastener strip 18 horizontally until the radial tracking wheel 53 in conjunction with the electronic programmable counting device 55 is capable of electronically disabling motors controlling the rotation of the spool 52. It is at this point that an assembly line operator can detach the continuous joined fastener strip 18 and remove the spool 52 of self-attaching fasteners, for use at a secondary installation site, and or perform any necessary inspections.

Of note, it is contemplated that any of the stations described above may have interchangeable components in order to manufacture varying types and sizes of self-attaching fasteners joined to wires.

The preferred embodiment of the present invention and method has been disclosed although a person of ordinary skill in the art would realize however, that certain modifications would come within the teachings of this invention. Therefore, the following claims should be studied to determine the true scope and content of the invention.

The invention claimed is:

1. A manufacturing apparatus and method of continuously manufacturing self-attaching fasteners having a predetermined width from a metal rod having a predetermined profile with grooves disposed there along and joining the fasteners with wires forming a continuous strip, comprising the steps of:
A. providing an articulating die press including a pierce punch area for piercing through holes in the metal rod, a hole sensing and pilot area for positioning the metal rod, a chamfer punch area for counter-sinking a portion of the pierced holes, a blanking area for cutting a self-attaching fastener to a predetermined width, a wire introduction area for introducing wires into the pre-formed grooves of the cut fastener, and a wire coining area for joining the fasteners and the two continuous wires together forming a continuous strip of self-attaching fasteners;
B. advancing the metal rod through a pierce punch area within a die press and piercing two holes through the metal rod;
C. advancing the metal rod through a hole sensing and piloting area within a die press and sensing and precisely positioning the metal rod;
D. advancing the metal rod through a chamfer punch area within a die press and forming a partial countersink on the pierced holes;
E. advancing the metal rod through a blanking area within a die press and cutting the metal rod to a predetermined width thus creating the width of a fastener and a cut edge of a second fastener;
F. advancing the cut fastener through the blanking area within a die press and cutting the metal rod to a predetermined width thus creating two fasteners;
G. advancing the cut fasteners through a wire introduction area within a die press where two continuous wires are introduced into the pre-formed grooves of the cut fasteners;
H. advancing the cut fasteners through the wire coining area within a die press where, in a two action process, the fasteners are spaced and joined to wires thus forming a continuous strip of joined fasteners;
I. then advancing the joined continuous fastener strip in a common plane through a timing mechanism;
J. providing a tapping/inspection/pulling machine which performs the operations of clamping or unclamping the joined fastener strip; inserting tappers into the pierced holes of the fastener strip thus forming internal threads in the holes of the individual fasteners; inspecting the threaded hole in the individual fasteners;
K. then advancing the joined fastener strip in a common plane to a spooling/reeling mechanism;
L. simultaneously counting the individual fasteners and reeling the continuous fastener strip onto a spool for use at a secondary installation site.

2. The method as set forth in claim 1, of cutting a self-attaching fastener free of burrs and deformation within a die press.

3. The method as set forth in claim 1, of introducing continuous wires into the pre-formed grooves of a self-attaching fastener within a die press.

4. The method as set forth in claim 1, of spacing self-attaching fasteners prior to joining fasteners to wires within a die press.

5. The method as set forth in claim 1, of joining wires to a self-attaching fastener within a die press resulting in a continuous joined strip of self-attaching fasteners.

6. The method as set forth in claim 1, of monitoring the advancement of the joined fastener strip in a common plane through a timing mechanism which controls the speed and operation of a die press and the speed and operation of a tapping/inspection/pulling machine.

7. The method as set forth in claim 1, of clamping and unclamping the joined fastener strip within the tapping/inspection/pulling machine.

8. The method as set forth in claim 1, of forming threads into the holes if the individual fasteners of the joined fastener strip within the tapping/inspection/pulling machine.

9. The method as set forth in claim 1, of inspecting the presence of or lack thereof a threaded hole in the individual fastener of a joined fastener strip within the tapping/inspection/pulling machine.

10. The method as set forth in claim 1, of advancing the joined fastener strip from the tapping/inspection/pulling machine in a common plane to a spooling/reeling mechanism.

11. The method as set forth in claim 1, of counting the individual fasteners in the joined fastener strip and reeling the continuous fastener strip onto a spool.
